(19) United States
(12) Patent Application Publication
(10) Pub. No.: US 2004/0222379 A1
(43) Pub. Date: Nov. 11, 2004

(54) Event counter for an imaging device

(76) Inventor: Michael Joseph Cook, Oconomowoc, WI (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/434,216

(22) Filed: May 9, 2003

(51) Int. Cl. G01T 1/164

(52) U.S. Cl. 250/363.03

(57) ABSTRACT

The invention relates to a device comprising a first memory; a first processor which receives data representing events categorized into a number of event types, wherein the first processor is programmed to store in the first memory a count value for each event type, and wherein the first processor is programmed to output instructions when the count value for one of the event types reaches a specified value greater than one; a second memory; and a second processor which is programmed to receive the instructions from the first processor and to increment in the second memory a count value based on the instructions received from the first processor.

### BACKGROUND OF THE INVENTION

The present invention relates generally to medical imaging, and more particularly to an event counter for a medical imaging device such as a positron emission tomography scanner.

A positron emission tomography (PET) scanner detects gamma rays which emanate from the patient. In a PET scan, the patient is initially injected with a radiopharmaceutical, which is a radioactive substance such as FDG ([¹⁸F] fluorodeoxyglucose) which emits positrons as it decays. Once injected, the radiopharmaceutical becomes involved in certain known bodily processes such as glucose metabolism or protein synthesis, for example. The emitted positrons travel a very short distance before they encounter an electron, at which point an annihilation event occurs whereby the electron and positron are annihilated and converted into two gamma rays. Each of the gamma ray has an energy of 511 keV, and the two gamma rays are directed in nearly opposite directions. The two gamma rays are detected essentially simultaneously by two of the detector crystals (also commonly referred to as “scintillators” or “scintillator crystals”) in the PET scanner, which are arranged in rings around the patient bore. The simultaneous detection of the two gamma rays by the two detector crystals is known as a “coincidence event.” The millions of coincidence events which are detected and recorded during a PET scan are used to determine where the annihilation events occurred and to thereby reconstruct an image of the patient.

Part of the image reconstruction process involves generating a data structure known as a histogram. A histogram includes a large number of cells, where each cell corresponds to a unique pair of detector crystals in the PET scanner. Because a PET scanner typically includes thousands of detector crystals, the histogram typically includes millions of cells. Each cell of the histogram also stores a count value representing the number of coincidence events detected by the pair of detector crystals for that cell during the scan. At the end of the scan the data in the histogram are used to reconstruct the image of the patient. The completed histogram containing all the data from the scan is commonly referred to as a “result histogram.” The term “histogrammer” generally refers to the components of the scanner, e.g., processor and memory, which carry out the function of creating the histogram.

As PET scanner technology advances, e.g., as detector crystals become faster and as PET scanners include greater numbers of detector crystals, the rate of data acquisition continues to increase. This increase places greater demands on the histogrammer. In general terms, the function of a histogrammer is to segregate and count events of a multi-type event stream, providing individual counts for each unique event type. For each event in the event stream, the histogrammer reads the current count value in a cell of the histogram, modifies the count value by incrementing or decrementing it, and writes the modified value back to the cell. In current PET scanners, the histogrammer may be required to process millions of events per second. Next generation PET scanners will likely place even higher demands on the speed of the histogramming function. The present invention addresses this need.

### SUMMARY

According to one embodiment, the invention relates to a device comprising a first memory; a first processor which receives data representing events categorized into a number of event types, wherein the first processor is programmed to store in the first memory a count value for each event type, and wherein the first processor is programmed to output instructions when the count value for one of the event types reaches a specified value greater than one; a second memory; and a second processor which is programmed to receive the instructions from the first processor and to increment in the second memory a count value based on the instructions received from the first processor.

According to another embodiment, the invention relates to a method of recording a count value for each of a number of event types comprising the steps of detecting events comprising the event types; storing in a first memory a count value for each event type, the count value representing the number of events which have occurred for the event type; incrementing the count value upon the occurrence of an additional event of the event type; and upon reaching a specified count value for the first memory for an event type, sending an instruction to a second memory to increment a corresponding count value for the event type by the specified count value.

### BRIEF DESCRIPTION OF THE DRAWINGS

FIG. 1 is a drawing of an imaging system according an exemplary embodiment of the invention;

FIG. 2 is a schematic diagram of the imaging system of FIG. 1;

FIG. 3 is a drawing depicting the coordinates r, z, θ, Φ used to define a projection plane data format;

FIG. 4 is a drawing of a detector block which forms part of the PET scanner of FIG. 1;

FIG. 5 is a diagram of a two-stage histogrammer according an exemplary embodiment of the invention;

FIG. 6 is a diagram of a two-stage histogrammer having a first stage with two nodes according to another embodiment of the invention;

FIG. 7 is a diagram of a three-stage histogrammer which utilizes a selective pass-through method according to another embodiment of the invention; and

FIG. 8 is a diagram of a three-phase histogrammer with a single CPU.

### DETAILED DESCRIPTION OF THE PREFERRED EMBODIMENTS

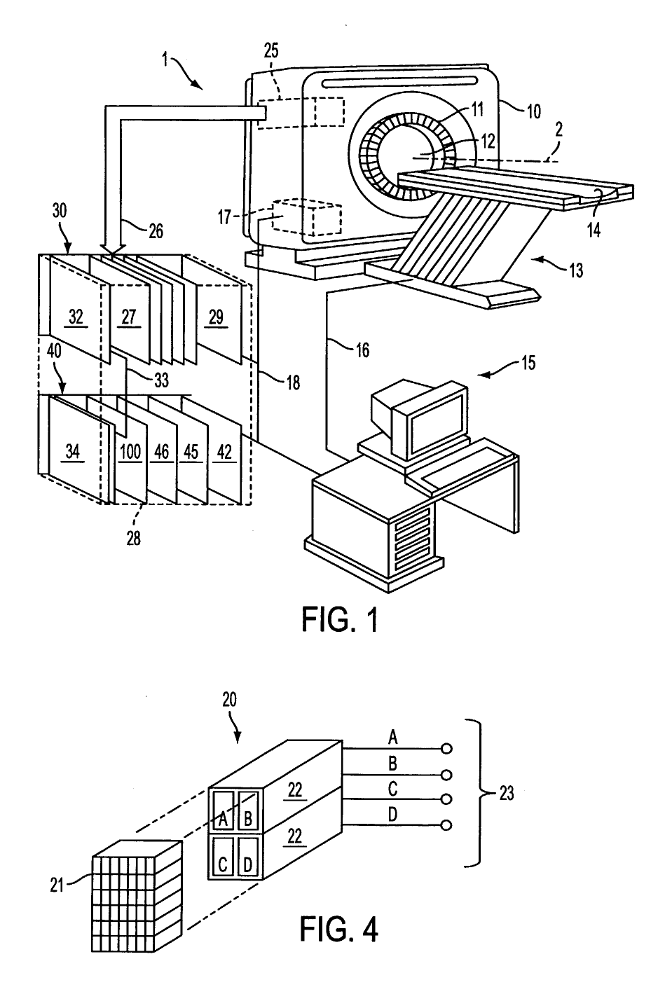

FIG. 1 illustrates a PET scanner 1 which includes a gantry 10 supporting a detector ring assembly 11 about a central opening or bore 12. The detector ring assembly 11 is circular in shape and is made up of multiple detector rings (not shown) that are spaced along a central axis 2 to form a cylindrical detector ring assembly. According to one embodiment, the detector ring assembly 11 includes 24 detector rings spaced along the central axis 2. A patient table 13 is positioned in front of the gantry 10 and is aligned with the central axis 2 of the detector ring assembly 11. A patient table controller (not shown) moves the table bed 14 into the bore 12 in response to commands received from an operator work station 15 through a serial communications link 16. A gantry controller 17 is mounted within the gantry 10 and is responsive to commands received from the operator work station 15 through a second serial communication link 18 to operate the gantry.

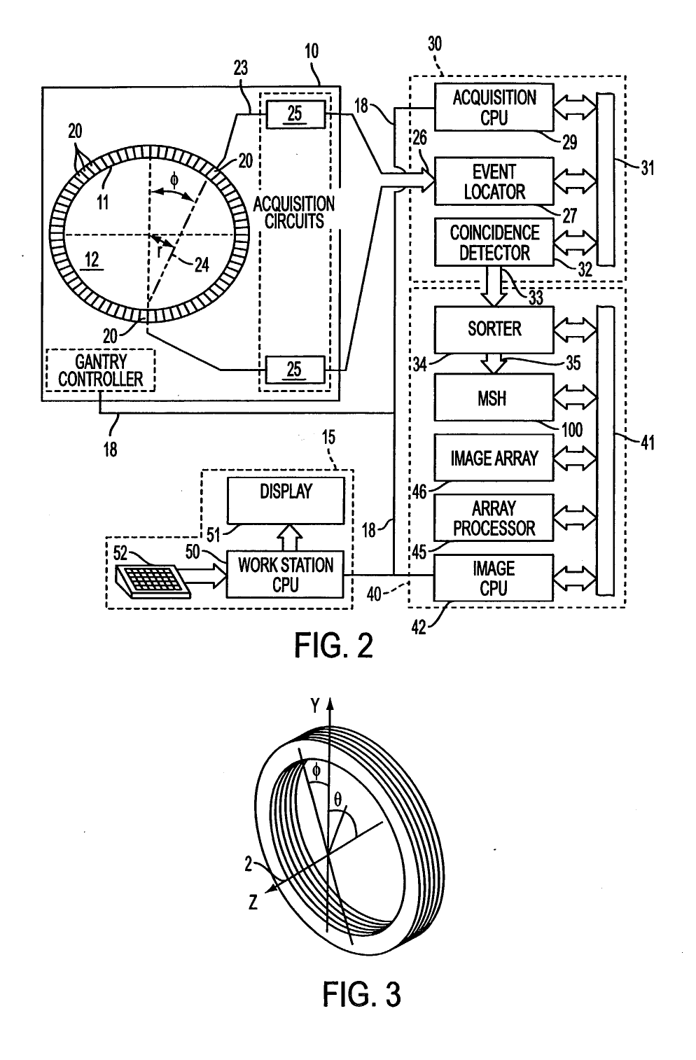

As shown in FIG. 2, the operator work station 15 includes a central processing unit (CPU) 50, a display 51 and a keyboard 52. Through the keyboard 52 and associated control panel switches, the operator can control the calibration of the PET scanner, its configuration, and the positioning of the patient table for a scan. Similarly, the operator can control the display of the resulting image on the display 51 and perform image enhancement functions using programs executed by the work station CPU 50.

The detector ring assembly 11 is comprised of a number of detector modules. According to one embodiment, the detector ring assembly 11 comprises 36 detector modules, where each detector module comprises eight detector blocks. An example of one detector block 20 is shown in FIG. 4. The eight detector blocks 20 in a detector module can be arranged in a 2×4 configuration such that the circumference of the detector ring assembly 11 is 72 detector blocks around, and the width of the detector ring 11 assembly is 4 detector blocks wide. Each detector block 20 typically comprises a number of individual detector crystals. For example, as shown in FIG. 4, each detector block 20 may comprise a 6×6 matrix of 36 detector crystals 21. The detector ring assembly 11 would thus have 24 detector rings. Each ring would have 432 detector crystals.

Each detector crystal 21 may comprise a scintillator formed, for example, of bismuth germanate (BGO). The 36 detector crystals in the block 20 are disposed in front of four photomultiplier tubes (PMTs) 22. Each PMT 22 produces an analog signal on one of the lines A-D shown in FIG. 4 which rises sharply when a scintillation event occurs then tails off exponentially. The position in the 6×6 detector crystal matrix at which the scintillation event took place determines the relative magnitudes of the analog signals, and the energy of the gamma ray which caused the event determines the total magnitude of these signals.

As shown in FIG. 2, a set of acquisition circuits 25 is mounted within the gantry 10 to receive the four signals from each of the detector blocks 20 in the detector ring assembly 11. The acquisition circuits 25 determine the event coordinates within the block of detector crystals 21 by comparing the relative signal strengths as follows:

x=(A+C)/(A+B+C+D)

z=(A+B)/(A+B+C+D)

These coordinates (x,z), along with the sum of all four signals (A+B+C+D) are then digitized and sent through a cable 26 to an event locater circuit 27 housed in a separate cabinet 28. Each acquisition circuit 25 also produces an event detection pulse (EDP) which indicates the exact moment the scintillation event took place. Of course, the above-described configuration of detector crystals, detector blocks, and detector modules is merely an example. Other configurations, sizes, and numbers of detector crystals, blocks and modules can be used, as will be appreciated by those skilled in the art.

The event locator circuits 27 form part of a data acquisition processor 30 which periodically samples the signals produced by the acquisition circuits 25. The data acquisition processor 30 has an acquisition CPU 29 which controls communications on the local area network 18 and a bus 31. The event locator circuits 27 assemble the information regarding each valid event into a set of digital numbers that indicate precisely when the event took place and the position of the detector crystal 21 which detected the event. The event data packets are transmitted to a coincidence detector 32 which is also part of the data acquisition processor 30.

The coincidence detector 32 accepts the event data packets from the event locator circuits 27 and determines if any two of them are in coincidence. Coincidence is determined by a number of factors. First, the time markers in each event data packet must be within a specified time period of each other, e.g., 12.5 nanoseconds, and second, the locations indicated by the two event data packets must lie on a straight line which passes through the field of view (FOV) in the scanner bore 12. Events which cannot be paired are discarded, but coincident event pairs are located and recorded as a coincidence data packet that is transmitted through a serial link 33 to a sorter 34. The format of the coincidence data packet may be, for example, a thirty-two bit data stream which includes, among other things, a pair of digital numbers that precisely identify the locations of the two detector crystals 21 that detected the event. For a detailed description of an example of a coincidence detector 32, reference is made to U.S. Pat. No. 5,241,181 entitled “Coincidence Detector For A PET Scanner.”

The sorter 34, which may comprise a CPU and which forms part of an image reconstruction processor 40, receives the coincidence data packets from the coincidence detector 32. The function of the sorter 34 is generally to receive the coincidence data packets and to generate from them memory addresses for the efficient storage of the coincidence data. The sorter 34 outputs a stream of histogram events to a histogrammer 100 downstream of the sorter via an interconnect 35 such as a bus.

According to one embodiment, the sorter 34 defines the coincidence events with respect to a projection plane format using four variables, r, z, θ, and Φ. As shown in FIG. 2, the variables r and Φ identify a plane 24 that is parallel to the central Z axis 2 of the detector, with Φ specifying the angular direction of the plane 24 with respect to a reference plane (defined as the Y-Z plane in FIG. 3) and r specifying the distance from the central Z axis 2 to the plane 24 as measured perpendicular to the plane 24. As further shown in FIG. 3, the variable θ defines an axial view angle parameter measured from the Y axis. The variable θ is used to define coincidence events involving detector crystals from different rings. The value of θ varies according to the separation distance of the two rings which detected a particular coincidence event. The value z specifies the location in the z direction of the midpoint between two different detector rings detecting a coincidence event.

The projection plane variables, r, z, θ, and Φ define the possible propagation paths taken by a pair of oppositely traveling gamma rays from an annihilation event to a pair of detector crystals 21. These propagation paths are commonly referred to as “lines of response” (LORs). Coincidence events occur at random, and the projection plane variables r, z, θ, and Φ can be used to sort or organize the coincidence events according to LOR, i.e., the direction of the gamma rays which generated the coincidence event. Ultimately, the coincidence events can be stored in a histogram organized in a logical order based on the projection plane variables r, z, θ, and Φ which define the LORs.

As will be appreciated by those skilled in the art, the sorter 34 can generate output data in other data formats, such as a set of sinogram arrays using only the variables r, Φ and z. In such case, the result histogram, i.e., the histogram containing all the data from the scan, could be in the form of a three-dimensional array based on the variables r, Φ and z. For a detailed description of an example of a sorter, reference is made to U.S. Pat. No. 5,272,343 entitled “Sorter for Coincidence Timing Calibration in a PET Scanner.”

The sorter 34 can additionally perform the function of generating a histogram cell address for each coincidence event in the form of a byte offset from the base address of the result histogram memory. Each histogram cell address corresponds to a histogram cell. As one example, the histogram for a set of projection planes could represent a four dimensional array with coordinates (r, z, θ, Φ), where “r” is the fastest changing index and “Φ” is the slowest changing index. According to one example, suppose r′, z′, θ′, and Φ′ represent the number of elements per index, respectively, for the four dimensional array (r, z, θ, Φ), where r′=250, z′=24, θ′=23, and Φ′=210. The cell address corresponding to r=5, z=2, θ=3, and Φ=4 can be computed, for example, as: histogram cell address=[(4×23×24×250)+(3×24×250)+(2×250)+5]×(number of bytes per cell). The generic formula for the histogram cell address would be: [((Φ×θ′×z′×r′)+(θ×z′×r′)+(z×r′)+r)]×(cell size).

The sorter 34 outputs a stream of histogram event packets, where each histogram event packet typically includes at least the following information: (a) a cell operation, e.g., increment by 1 or decrement by 1; and (b) a histogram cell address. According to one embodiment, a histogram event packet comprises a 29 bit stream where the first bit indicates the binary operation “increment by 1” or “decrement by 1,” and the subsequent 28 bit stream represents the histogram cell address. According to another embodiment, a histogram event packet can comprise a 32 bit stream where the first four bits indicate an increment value of 1 though 8 or a decrement value of 1 through 8, followed by a 28 bit stream representing the histogram cell address.

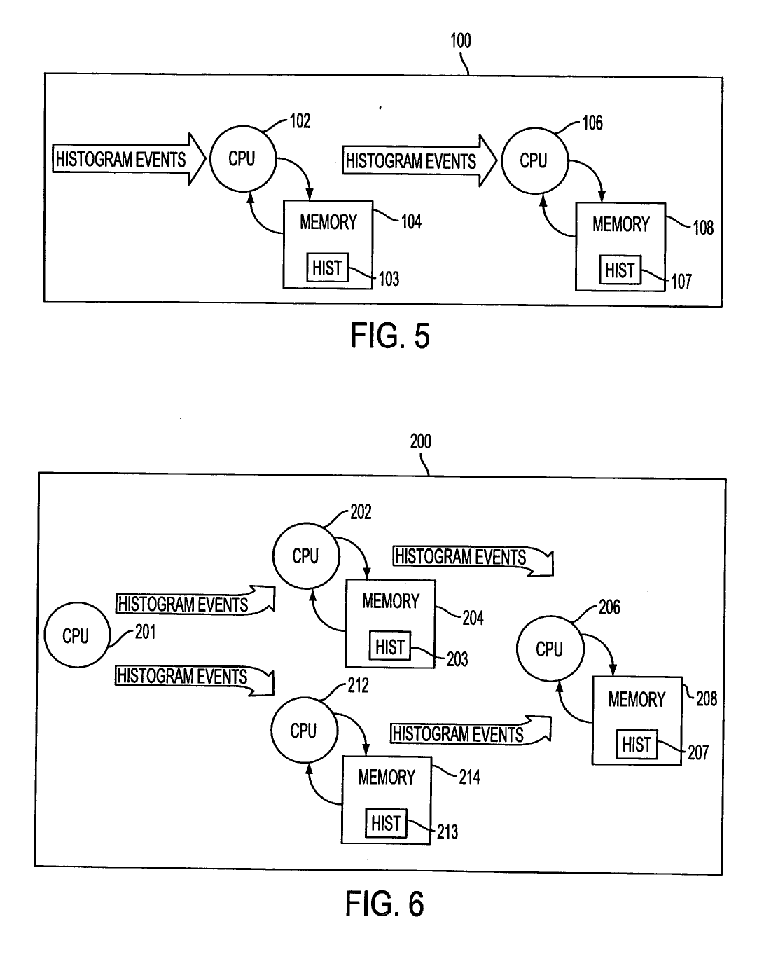

The multi-stage histogrammer (MSH) 100, which receives the histogram event packets from the sorter 34, is shown in more detail in FIG. 5 according to an exemplary embodiment of the invention. The multi-stage histogrammer 100 includes a first stage CPU 102, a first stage memory 104, a second stage CPU 106, and a second stage memory 108. The first stage CPU 102 and first stage memory 104 together form a first stage histogrammer, while the second stage CPU 106 and the second stage memory 108 together form a second stage histogrammer. The second stage histogrammer may also be referred to as a final stage histogrammer. A histogrammer stage such as the first stage which is not the final stage may be referred to as an intermediate stage histogrammer. The first stage histogrammer includes a first or intermediate stage histogram 103. The final stage histogrammer includes a result histogram 107. The final stage histogram may be referred as a “result histogram” because it stores all the resulting data from the scan. The first stage CPU 102 receives the histogram event packets from the sorter 34. The first stage CPU 102 reads and writes data to and from the first stage memory 104. The first stage CPU 102 also sends data to the second stage CPU 106. The second stage CPU 106 reads and writes data to and from the second stage memory 108.

For each event in the event stream, each histogrammer stage reads the current count value in the corresponding histogram cell, modifies the count value by incrementing or decrementing it, and writes the modified value back to the cell. This cycle is commonly referred to as a “read-modify-write” cycle. As one example of a read-modify-write cycle, the first stage CPU 102 might receive a histogram event packet from the sorter 34 specifying a particular histogram cell and an instruction to increment the corresponding count value by one. The first stage CPU 102 would read the existing count value in the appropriate cell of the histogram 103, e.g., a value of 2, modify the value to 3, and write the new value to the histogram cell. The histogramming performance, e.g., the ability to segregate and count many events in a given amount of time, may be dependent to a significant extent on the read-modify-write speed of the particular histogram memory. The histogrammer stage also tests the cell for an overflow or underflow condition, i.e., a value higher or lower than a specified range. If cell overflow occurs, an exception is raised. If cell underflow occurs, the cell value is typically reset to a count value of zero.

According to an exemplary embodiment of the invention, the first stage memory 104 comprises a cache memory and the second stage memory 108 comprises a system memory. System memory refers to the bulk memory normally associated with a computer. An example of system memory is random access memory (RAM). The cache memory generally operates at a significantly faster rate than the system memory. An example of CPU cache memory is what is commonly referred to as Level 2 (L2) or Level 3 (L3) cache. Cache memory is typically more expensive than system memory given its performance benefit and thus the amount of cache memory versus cheaper, slower system memory is typically a performance versus cost architectural trade-off associated with a computer. Although not shown in FIG. 5, the first stage histogrammer may further comprise an associated system memory, and the second stage histogrammer may further comprise an associated cache memory, if desired.

The CPUs 102, 106 are interconnected such that data transfer between the CPUs is efficient, typically requiring little if any CPU cycles to move data between the CPUs. Examples of efficient interconnects include high speed buses (e.g., Infiniband) and/or switched fabrics (e.g., Raceway++). The bus may include a Direct Memory Access (DMA) engine associated with it which effectively offloads the CPU for data movement, freeing the CPU to perform additional processing.

Because cache memory typically operates at a significantly higher rate than system memory, it is generally desirable to utilize the cache memory to increase the speed of the histogramming function. However, the cache memory, which may be on the order of 0.5 to 2.0 megabytes (MB), for example, is generally not large enough to store all of the event data generated during a PET scan. As mentioned above, a PET scanner may include 24 detector rings, each having 432 detector crystals. The number of combinations of pairs of detectors may yield histograms having on the order of thirty million cells, for example. Depending on the particular details of the scan, it may be desirable or necessary for each cell in the histogram to be 2 bytes (16 bits) in size. A 2-byte cell size allows count values to be stored up to 2¹⁶−1=65,535. The result histogram for such a system could therefore be on the order of 60 MB.

According to exemplary embodiments of the invention, the first processor 102 stores a first stage histogram 103 in the cache memory 104 which is smaller in size than the result histogram 107 stored in the system memory 108. The first stage histogram 103 has a corresponding cell for each cell in the result histogram, but the size of each cell of the first histogram 103 is smaller. For example, the cell size of the first histogram may be 1, 2, 4, or 8 bits (with respective count ranges of 0-1, 0-3, 0-15, 0-255), while the cell size for the result histogram may be 8 or 16 bits (with respective count ranges of 0-255 and 0-65,535). The size of the first stage histogram 103 is typically comparable to or matched to the size of the cache memory 104. The size of the first stage histogram 103 is typically not greater than the size of the cache memory 104. The intermediate stages of the histogrammer will generally have the largest cell size that allows the intermediate stage histogram to fit into the cache memory for that stage. For example, if the result histogram has 4 million cells with a cell size of 16 bits for a total size of 8 MB, and the cache memory of the intermediate histogram is 2 MB, the cell size for the first stage histogram could be 4 bits.

For a computer implementation having a cache memory two times faster than its system memory, the two-stage histogrammer shown in FIG. 5 would typically have a predicted performance of at least two times that of a conventional single stage histogrammer (two times as many events handled in a given amount of time) and potentially reduce the processing required at the final stage by a factor of 16. A conventional prior art single stage histogrammer includes an arithmetic logic unit (ALU) or custom electronics for performing read-modify-write cycles and a random access memory to process events from a sorter and to construct a result histogram.

Referring again to FIG. 5, in addition to storing events in the cache memory 104, the first stage CPU 102 also propagates events to the second stage CPU 106. The first stage CPU 102 receives input events from the sorter 34 with instructions to increment by 1 or decrement by 1 the count value. The first stage CPU 102 can output events that have an increment or decrement value greater than one. The first stage CPU 102 thus acts as an event stream reducer for the second stage CPU 106. Typically, the first stage CPU 102 propagates a histogram event to the next stage when a cell of the first stage histogram 103 reaches an overflow or underflow value. When the first stage CPU 102 detects an overflow or underflow condition in a cell of the first stage histogram 103, the first stage CPU 102 resets the cell value to a predetermined reset value (sometimes referred to as a “bias” value) in addition to propagating an event to the next stage.

As one example, the first stage CPU 102 might receive a histogram event packet from the sorter 34 specifying a particular histogram cell and an instruction to increment the corresponding count value for that cell by one. The first stage CPU 102 would read the existing count value, e.g., a value of 3, in the histogram cell. The first stage CPU 102 would then increment the count value to 4 and perform a check to determine whether the modified count value causes an underflow or overflow condition. In this case, if the cell size is 2 bits, i.e., holds values of 0, 1, 2, or 3, then an overflow condition would be detected. Rather than writing a 4 into the cell of the first stage histogram 103, the first stage CPU 102 would generate a histogram event packet specifying the relevant cell and an instruction for the second stage CPU 106 to increment the second stage histogram 107, in this case the result histogram, by 4. The first stage CPU 102 would also reset the count value in the relevant cell of the first stage histogram 103.

The reset value may be selected based on whether the event stream contains ‘decrement’ events. Decrement events are used to make corrections in cases where coincidence events generated by the coincidence detector 32 are subsequently determined to be inaccurate due to false readings. In some configurations, decrement events are not included in the event stream. If decrement events are not included, the reset value for the cells in the first stage histogram 103 is typically selected to be zero.

If the event stream includes decrement events, the reset value is typically not set to zero, since a subsequent decrement event would then cause an underflow condition. Instead, the reset value may be selected in consideration of a worst case expected ratio of increments to decrements. The worst case ratio of increments to decrements (also sometimes referred to as “prompts” and “delays,” respectively) typically occurs during 3D scanning at a high count rate, where the ratio may approach 1:1. The reset value in this case may be a number between zero and the maximum count value for the cell.

If the event stream is framed with respect to time and/or an external event such as a physiological trigger (as may be the case for PET scans), the event stream may include a means of embedding a frame event into the event stream. For example, the sorter 34, or another upstream component, can be programmed to embed a frame event into the event stream. In such a case, the first stage CPU 102 may be programmed to recognize the frame event and to flush out all the events in the first stage histogram 103 to the second stage histogrammer. The cells in the first stage histogram 103 are then reinitialized to the reset value before processing any additional input events.

The flushing of the first stage histogram 103 to the second stage histogram 107 can be an opportunity to apply Single Instruction Multiple Data (SIMD) CPU technology to construct the output events based on the current count values of the cells of the first stage histogram 103. SIMD technology allows one instruction to operate at the same time on multiple data items. SIMD technology may be effective if the operands and results represent sequential data sets, which can be the case for the intermediate compressed histograms. The second stage histogrammer can also be configured to directly access the first stage intermediate histogram and directly and more efficiently process the intermediate histogram with fewer CPU cycles and have the results reflected in the second stage histogram.

At the end of the scan, all of the intermediate stage histograms are flushed a final time to send all of the data in the intermediate stage histograms to the result histogram. The result histogram 107 generated by the final stage histogrammer will therefore contain all of the data from the scan. The result histogram 107 is used to construct an image of the patient according to tomography methods well known in the art. Reference is made, for example, to U.S. Pat. No. 5,272,343 entitled “Sorter for Coincidence Timing Calibration in a PET Scanner.” As shown in FIG. 2, an array processor 45 is provided to reconstruct an image from the data in the result histogram. First, however, a number of corrections may be made to the acquired data to correct for measurement errors such as those caused by attenuation of the gamma rays by the patient, detector gain nonuniformities, random coincidences, and integrator deadtime, for example. Each row of the corrected result histogram 107 may then be Fourier transformed by the array processor 45 and multiplied by a one-dimensional filter array. The filtered data is then inverse Fourier transformed, and each array element is backprojected to form the image array 46. The image CPU 42 shown in FIG. 2 may either store the image array data on disk or tape (not shown) or output it to the operator work station 15.

According to other embodiments of the invention, one or more stages of a multi-stage histogrammer can have two or more nodes. This configuration may be advantageous, for example, in applications having histograms with a large number of cells. An intermediate stage histogrammer may include two or more nodes, for example, with each node providing a cache memory, so that the total cache memory is increased as compared with an intermediate stage histogrammer having a single node. In such a configuration, an event stream splitter is provided to split the input event stream between the two or more nodes. A downstream stage may be configured to accept events from more than one stream.

An example of a two-stage histogrammer with two nodes on the first stage is shown in FIG. 6. All of the stages of the two-stage histogrammer 200, except typically the final stage, can utilize the speed of cache memory described above with respect to FIG. 5 to enhance performance. The intermediate stage histogrammers act as event stream reducers for the final stage histogrammer, as in the FIG. 5 example.

Referring to FIG. 6, the two-stage histogrammer 200 includes an event stream splitter 201 which receives an event stream from the sorter 34 and which splits the input stream into two output streams according to one or more predetermined criteria. According to one example, the event stream splitter 201 may divide the single histogram event stream into two histogram event streams, where one output stream contains only histogram event packets having histogram cell addresses that are odd (as opposed to even), and the other output stream contains histogram event packets having histogram cell addresses that are even (i.e., divisible by 2). According to another example, the event stream splitter 201 divides the stream into two streams based on a range of histogram cell addresses. For example a first output stream has packets that contain only histogram cell addresses 0 though 1,000,000 and a second output stream has packets that contain only histogram cell addresses 1,000,001 through 2,000,000. This segregation rule can also be expressed in terms of A type events having cell offsets 0 thru N/2 and B type events have cell offsets N/2+1 thru N, where N is the number of cells in the final result histogram.

FIG. 6 also shows a first node of a first stage histogrammer comprising a CPU 202, a memory 204, and a histogram 203; a second node of the first stage histogrammer comprising a CPU 212, a memory 214 and a histogram 213; and a second stage (single-node) histogrammer comprising a CPU 206, a memory 208 and a result histogram 207. The memories 204 and 214 of the first stage histogrammer are typically cache memories which operate at a higher speed than the memory 208 of the second stage histogrammer, which is typically a system memory. The CPUs in FIG. 6 are interconnected such that data transfer between the CPUs is efficient, for example using high speed buses and/or switched fabrics. According to one example, each of the histograms 203 and 213 may contain 16 million 1-bit cells for a total size of 2 MB, and the result histogram 207 may contain 32 million 16-bit cells for a total size of 64 MB.

The event stream splitter 201 typically balances the output event streams so that they are of comparable size to avoid overloading a particular node which might degrade the overall stream throughput. According to one embodiment, the event splitter 201 comprises a CPU dedicated to the event splitting function. The event splitter function may also be achieved by the sorter 34 or one of the intermediate histogrammer CPUs. In such a case, the performance of the sorter 34 or histogrammer 102 may be degraded by some amount due to the added workload of event splitting.

For many applications, it may be beneficial if the format of the event stream into and out of the intermediate histogrammer stages and nodes is substantially identical in definition to the input to the final stage histogrammer. Such a configuration generally allows more flexibility in configuring the number of intermediate histogrammer stages and nodes for applications that may have to produce result histograms of varying size and/or have different count rate capability requirements.

The cell address for the histogram event streams into and out of the intermediate stage histogrammers is typically expressed as a byte offset from the starting address of the result histogram of the final stage rather than an absolute address. To provide an example, referring to FIG. 5, the result histogram 107 could be physically mapped to CPU 106 system memory 108 at address 5,000,000. A cell address in a histogram event packet of 888 would imply an offset of 888 bytes from the start of the result histogram located at 5,000,000 of CPU 106 system memory. In this case, the absolute cell address in the result histogram would be 5,000,888. The final stage histogrammer would add 5,000,000 to the cell offset specified in the histogram event packet to get the absolute cell address in its system memory. However, at the intermediate stage, the intermediate histogram may be mapped at cache memory 104 address 30,000. And if the cell size of the intermediate histogram was 4 bits (as opposed to an 8 bit size for the result histogram), the cell offset of 888 of the histogram event packet would be converted to 444 and added to 30,000 to get the absolute cache address of 30,444 of the cell when mapped at CPU 102. The logic to convert a result histogram cell address (offset) to a corresponding intermediate stage histogram cell address, and vice-versa, is typically not a CPU-intensive operation. In most cases, this conversion operation requires just a few CPU register shift and/or mask instructions per event.

According to another embodiment of the invention, one or more intermediate stage histogrammers can be configured to process only a predefined subset of the event types in the input data stream. In other words, not all events presented to an intermediate stage histogrammer need be processed by the intermediate stage histogrammer. An intermediate stage histogrammer can be configured to process only a subset of the events in the input data stream and to propagate the unprocessed events directly to the next stage histogrammer. This method may be advantageous where, for example, the amount of available cache memory per stage or node is limited.

This method, which may be referred to as a “selective pass-through” method, may be particularly effective if the subset of event types to be processed by the first stage histogrammer is defined to include cells that are known to have higher than average count rates. In this way, the faster cache memory is effectively utilized to process the cells which are known to typically have high count rates, whereas the other cells with slower count rates are processed by a later stage histogrammer which may use system memory rather than cache memory. The selective pass-through method can thus be configured such that the events selected for processing by a particular intermediate stage histogrammer are mapped to the relevant intermediate stage histogrammer, i.e., are within the address range of the intermediate stage histogrammer, while unprocessed events passed through are outside the address range for the intermediate stage histogrammer.

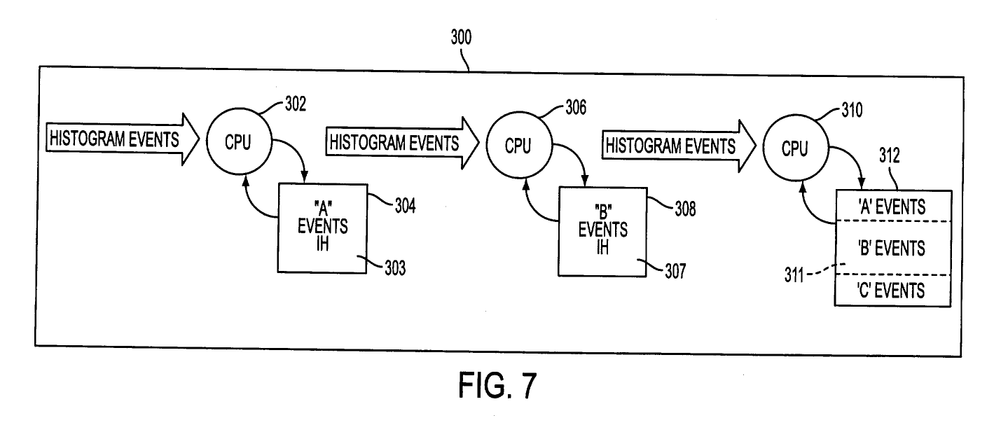

Referring to FIG. 7, the multi-stage histogrammer 300 includes a first stage CPU 302, memory 304, and histogram 303, a second stage CPU 306, memory 308, and histogram 307, and a final stage CPU 310, memory 312, and result histogram 311. Typically, the first stage memory 304 is a cache memory and the final stage memory 312 is a system memory. The intermediate stage memory 308 may be either a cache memory or a system memory. As one example, the histogram 303 may contain 8 million 2-bit cells for a total size of 2 MB, the histogram 307 may contain 16 million 1-bit cells for a total size of 2 MB, and the result histogram 311 may contain 26 million 16-bit cells for a total size of 52 MB.

FIG. 7 illustrates three types of events, i.e., A events, B events, and C events. According to one embodiment, the A events are a predefined subset of event types including cells having the highest count rates. The B events are a predefined subset of event types including cells having an average count rate. The C events are a predefined subset of event types including cells having a relatively low count rate. For typical PET scans, the cells having the highest counts per cell are typically those lines of response (LOR) that have small values of the index “r,” as shown in FIG. 2. Typically, “r” is the fastest changing index for the sinogram format and the projection plane format. However, if the sinogram and projection plane formats are configured such that the “r” index is the slowest changing index, e.g., the typical projection plane coordinates (r, z, θ, Φ) are modified to be (z, θ, Φ, r), then the cells with small “r” values will be concentrated at the beginning of the result histogram. Reordering the PET LOR histograms to have the radial components being the slowest changing index in the multi-dimensional LOR histogram as a method of concentrating the counts to a sub-region of the result histogram can enhance performance by assigning the event types having the higher than average count rates to the histogrammer or histogrammers having the faster performance.

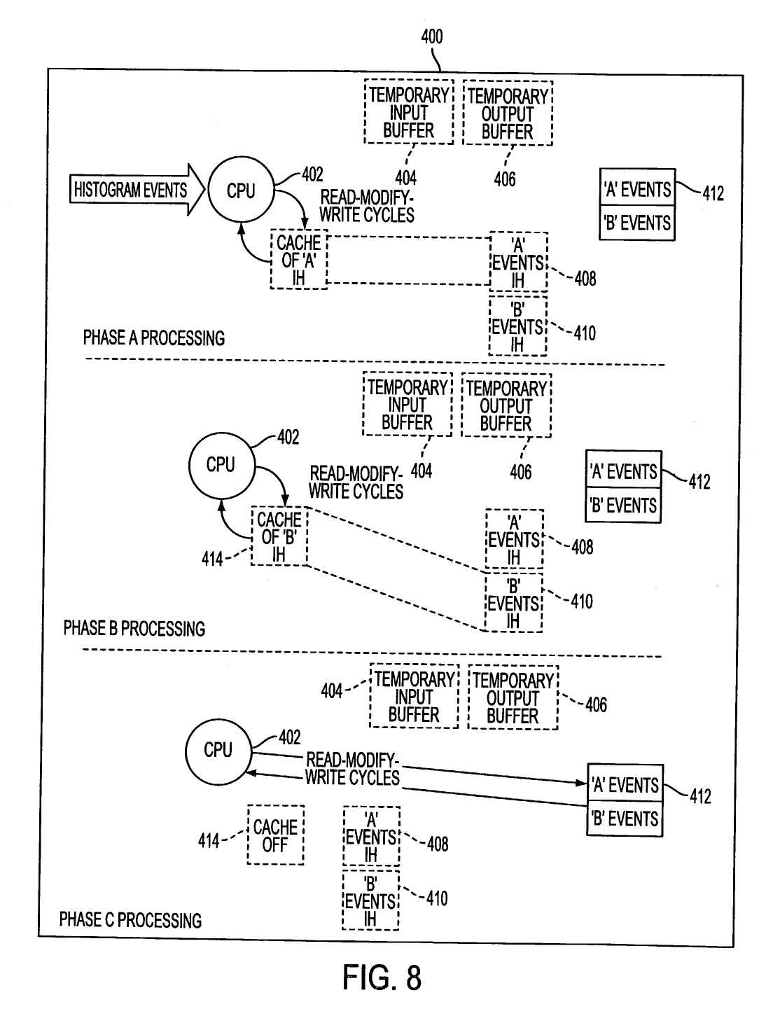

In the embodiments and examples described above, the multistage histogrammers are implemented with at least one CPU for each stage. However, other configurations can be implemented. For example, a single CPU can be used to perform the functions of two histogrammers from different stages and/or the functions of two histogrammers from different nodes on a stage. An example of such a system is shown in FIG. 8.

FIG. 8 shows a multi-phase configuration utilizing cache management techniques which can be implemented, for example, if the available cache and system memory resources are less than desired for a given application. The system shown in FIG. 8 is an example of a single CPU, multi-phase histogrammer.

FIG. 8 depicts three phases A, B and C of the multi-phase histogrammer 400 all being performed on a system with a single CPU 402, single cache and single system memory. FIG. 8 shows a temporary input buffer 404, temporary output buffer 406, intermediate histogram for A events 408, intermediate histogram for B events 410, and a result histogram 412, which are all resident in different portions of the system memory associated with the CPU 402. The intermediate histograms 408, 410 are also cached in the cache memory 414 during formation. According to one embodiment, the cache memory 414 may contain 8 million 2-bit cells for a total size of 2 MB, each of the intermediate histograms 408, 410 may contain 8 million 2-bit cells for a total size of 2 MB each, and the result histogram 412 may contain 16 million 16-bit cells for a total size of 32 MB.

In the example shown in FIG. 8, a time slice method is utilized to execute the three phases. During a first period of time, the histogrammer 400 operates in the A phase. During a second period of time, the histogrammer 400 operates in the ″B phase. During a third period of time, the histogrammer 400 operates in the C phase. This three-phase cycle will typically be repeated many times throughout the processing of the event stream.

In general, the cache memory mirrors the most frequently accessed system memory. The cache controller of a computer system is predictive, i.e., it prefetches and/or keeps in the faster cache memory a subset of the slower system memory that is likely to be, or has recently been referenced. When the CPU references a memory location (e.g., for a read or write of a memory cell), the memory reference will take less time if it is currently mirrored in the cache memory. This is referred to as a “cache hit.” If the memory reference is not in the cache, it is referred to as a “cache miss.” The term “mirrored” is used to mean that we are achieving a high ratio of “cache hits” to “cache misses.” Since cache memory is typically limited in size relative the bulk system memory, the cache controller may have to flush less recently referenced data back out to system memory in order to make room for a new memory reference that is not currently in cache. Although cache memory is typically enabled by default since it benefits many applications, computer systems typically provide a means to disable it for applications that might not be suited for the default predictive cache memory management rules.

In addition to cache enables/disables, the default cache controller behavior can typically be overridden with explicit “cache hints” and/or “cache flushes.” Cache hints are suggestions to the cache controller of system memory locations that will soon be referenced. Cache flushes suggest to the cache controller that the specified cache memory locations will not be referenced again in the near future and therefore can be written back out to system memory and then freed for use of an upcoming memory reference.

The histogrammer of FIG. 8 can utilize cache memory management to take advantage of default cache controller predictive rules, in addition to explicit cache hints, cache flushes and cache enables/disables, for example. The histogrammer 400 can be configured, for example, so as to utilize the cache memory 414 for the intermediate histogram structures if the current phase is A or B, but to disable the cache memory 414 for phase C.

The three phases operate as follows. At the start of phase A, an arbitrary number of histogram events e.g., 500,000, is temporarily stored in the temporary input buffer 404. Then, the histogrammer 400 enables the cache 414 and scans the events in the temporary input buffer 404 for A type events (i.e., events that have offsets corresponding to the A region of the result histogram 412). For each A event, the histogrammer 400 performs the read-modify-write operation for the corresponding A event in the intermediate histogram 408. If the event results in overflow (or underflow) for the cell of the intermediate histogram, an output event is constructed and placed in the temporary output buffer 406. The output event may contain an instruction such as “increment by 4” (or “decrement by 1” if underflow), for example. The cell bias value may be zero, for example.

Since the cache memory 414 is enabled during phase A, the A intermediate histogram is eventually cached resulting in better performance the more A events are processed. Each time an A event is read from the temporary input buffer 404, the cell associated with the A event is brought into (if not already) the cache memory 414. This cache mirroring is depicted in FIG. 8 by the horizontal lines that extend from the A intermediate histogram 408 to the cache memory 414. Since the A intermediate histogram 408 is matched in size to the cache memory 414, few cache misses occur. When all A events in the temporary input buffer 404 have been processed, the A intermediate histogram in cache memory 414 is flushed to the system memory 408 with an explicit cache flush, which completes the A phase. At this point, the temporary output buffer 406 also contains increment instructions corresponding to the overflow and underflow events occurring during phase A.

At the start of phase B, the histogrammer 400 rescans the events in the temporary input buffer 404 for B type events (i.e., events that have offsets corresponding to the B region of the result histogram 412). For each B event encountered in the temporary input buffer 404, the read-modify-write operation for the corresponding B event in the intermediate histogram 410 is performed. If the event results in overflow (or underflow) for the cell of the intermediate histogram, an output event is constructed and appended in the temporary output buffer 406. The output event may contain an instruction such as “increment by 4” (or “decrement by 1” if underflow), for example.

Since the cache 414 is enabled, the B intermediate histogram 410 is eventually mirrored into the cache memory 414 due to the B intermediate histogram referencing. This results in better performance the more B events are processed. This mirroring is depicted in FIG. 8 by the lines that extend from the B intermediate histogram 410 to the cache memory 414. Since the B intermediate histogram 410 is matched in size to the cache memory 414, few cache misses occur. When all B events in the temporary input buffer 404 have been processed, the B intermediate histogram in the cache memory 414 is flushed to system memory 410 with an explicit cache flush, which completes the B phase. At this point, the temporary output buffer 406 also contains increment instructions corresponding to the overflow and underflow events occurring during phase B.

At the start of the C phase, the cache is disabled to avoid cache thrashing that would typically result when the result histogram 412 is randomly referenced as a function of phase C processing. Then, all events in the temporary output buffer 406 that were created as a function of phase A and B are processed with the corresponding memory read-modify-write cycles directed toward the result histogram 412. This completes the phase C processing.

The sequence of phases A, phase B, phase C processing can be repeated for as long as necessary to process the event stream. In general, the more time spent in each phase, the higher the expected histogrammer performance. Time spent per phase is a function of the number of events accumulated in the temporary input buffer 404 at the start of each A phase. During phases A and B, it may be beneficial to bypass the cache (or use cache flushes) when referencing the temporary input buffer 404 and/or the temporary output buffer 406 in order to avoid contaminating the intermediate histogram mirrored in the cache. When the entire scan is completed, the intermediate histograms 408, 410 are also flushed to the result histogram 412, in addition to the increment and decrement instructions in the temporary output buffer 406.

Other configurations of a multi-phase or multi-stage histogrammer can be utilized. For example, an MSH can be configured to have two stages, with phases A and B on the first stage and phase C on the second stage.

The multi-stage histogram method can also be achieved using a custom electronics solution. For example, Field Programmable Gate Array (FPGA) technology can be programmed to perform the arithmetic operations associated with read-modify-write memory cycles, including testing for overflow and underflow. Thus a programmed FPGA can perform the functions of a histogrammer CPU. FPGAs may also have registers that can serve as cache memory and/or system memory. FPGAs typically vary in performance and cost. Some FPGAs may give comparable cache memory performance. Thus, according to an exemplary embodiment of the invention, a multi-stage histogrammer may comprise small, fast FPGAs as the intermediate histogrammer nodes, and slower FPGAs for the final stage histogrammer. FPGAs can also be utilized for the multi-phase embodiment of FIG. 8.

The principles of embodiments of the invention can also be applied to other components of a scanner, such as the sorter 34 shown in FIG. 2. For example, the sorter 34 can be constructed to have a CPU which receives the coincidence data packets from the coincidence detector 32 and a cache memory which stores count values for each histogram cell. According to this embodiment, the sorter 34 performs the functions of generating the histogram cell addresses for each coincidence data packet, storing a count value for each cell, and outputting a stream of histogram events which include a histogram cell address and a cell operation such as increment by 1, 2, 3, . . . or decrement by 1, 2, 3 . . . , i.e., a value other than 1. In this embodiment, the sorter 34 acts as an event stream reducer for the downstream histogram stage.

The multi-stage histogrammer method has been described in the context of a PET scanner application. However, the multi-stage histogrammer method is not limited to PET scanners and can be applied to other applications such as Nuclear Camera Imaging, Computed Tomography, and live 2D oscilloscopes, which generate a histogram of events.

While the foregoing specification illustrates and describes the preferred embodiments of this invention, it is to be understood that the invention is not limited to the precise construction disclosed herein. The invention can be embodied in other specific forms without departing from the spirit or essential attributes. Accordingly, reference should be made to the following claims, rather than to the foregoing specification, as indicating the scope of the invention.

What is claimed is:

1. A device comprising:
a first memory;
a first processor which receives data representing events categorized into a number of event types, wherein the first processor is programmed to store in the first memory a count value for each event type, and wherein the first processor is programmed to output instructions when the count value for one of the event types reaches a specified value greater than one;
a second memory; and
a second processor which is programmed to receive the instructions from the first processor and to increment in the second memory a count value based on the instructions received from the first processor.

2. The device of claim 1, wherein the events are coincidence events from a Positron Emission Tomography (PET) scan.

3. The device of claim 1, wherein the event types are defined by a line of response in a PET scanner.

4. The device of claim 1, wherein the event types are defined by a combination of two detector crystals in a PET scanner.

5. The device of claim 1, wherein the first memory operates at a higher speed than the second memory.

6. The device of claim 5, wherein the first memory is a cache memory and the second memory is a system memory.

7. The device of claim 5, wherein the first memory has a smaller storage capacity than the second memory.

8. An imaging device comprising:
a plurality of detectors;
means for generating a data stream of events detected by the detectors, wherein the events are categorized into a number of event types;
a first memory which stores data according to a first histogram data structure, the first histogram data structure comprising a number of cells, wherein each cell corresponds to one of the event types and contains a corresponding count value;
a first processor which receives the data stream of events and which is programmed to (a) increment the count values in the cells of the first memory and (b) output instructions when one of the count values reaches a specified value;
a second memory which stores data according to a second histogram data structure, the second histogram data structure comprising a number of cells, wherein each cell corresponds to one of the event types and contains a corresponding count value;
a second processor which receives the instructions from the first processor and which increments the count values in the second memory in response to the instructions.

9. The imaging device of claim 8, wherein the cells in the first histogram data structure have a one-to-one correspondence with the cells in the second histogram data structure.

10. The imaging device of claim 8, wherein the first histogram data structure is configured to store data on events in only a subset of the event types.

11. The imaging device of claim 8, wherein the first processor is programmed to read the event type for each event in the data stream and to increment the count values in the histogram cells of the first memory for only a subset of the event types.

12. The imaging device of claim 11, wherein the subset of event types is defined to include event types having a count rate which is greater than an average count rate for all event types.

13. The imaging device of claim 8, wherein the first histogram data structure comprises a sinogram format.

14. The imaging device of claim 8, wherein the first histogram data structure comprises a projection plane format.

15. The imaging device of claim 8, wherein the first processor increments the count values in the histogram cells of the first memory by reading one of the count values, modifying the count value, and writing the modified count value to the histogram cell.

16. The imaging device of claim 8, wherein the second memory comprises random access memory.

17. The imaging device of claim 8, wherein the cells in the first histogram data structure have a size of 2 bits and the cells in the second histogram data structure have a size of at least 8 bits.

18. The imaging device of claim 8, wherein the events are coincidence events from a PET scan.

19. The imaging device of claim 8, wherein each of the event types are defined by a combination of two of the detectors.

20. The imaging device of claim 8, wherein the event types are defined by a line of response between two of the detectors.

21. The imaging device of claim 8, wherein the first memory operates at a higher speed than the second memory.

22. The imaging device of claim 8, wherein the first memory is a cache memory, and the second memory is a system memory.

23. The imaging device of claim 8, wherein the first memory has a smaller capacity than the second memory.

24. The imaging device of claim 8, wherein the specified value is greater than one.

25. A method of recording a count value for each of a number of event types comprising the steps of:
detecting events comprising the event types;
storing in a first memory a count value for each event type, the count value representing the number of events which have occurred for the event type;
incrementing the count value upon the occurrence of an additional event of the event type;
upon reaching a specified count value for the first memory for an event type, sending an instruction to a second memory to increment a corresponding count value for the event type by the specified count value.

26. A method of generating a result histogram for a positron emission tomography (PET) scan comprising the steps of:
detecting events;
generating a data stream of events, wherein the events are categorized into a number of event types;
reading the data stream of events with a first processor;
incrementing count values in a first memory with the first processor based on the data stream of events, the first memory storing data according to a first histogram data structure, the first histogram data structure comprising a number of cells, wherein each cell comprises an address corresponding to a particular event type and a corresponding count value for the event type;
outputting instructions with the first processor when a count value in the first memory reaches a specified value;
reading the instructions with a second processor; and
incrementing count values in a second memory with the second processor, the second memory storing data according to a second histogram data structure, the second histogram data structure comprising a number of cells, wherein each cell comprises an address corresponding to a particular event type and a corresponding count value, wherein the second memory, upon completion of the PET scan, holds the result histogram.

27. The method of claim 26, wherein each event type corresponds to a line of response for the PET scan.

28. A method comprising the steps of:
storing a plurality of events in a temporary input buffer, the plurality of events being categorized into at least a first event type and a second event type;
enabling a cache memory;
incrementing count values for a first intermediate histogram of the first event type utilizing the cache memory;
outputting incrementing instructions with respect to the first event type to a temporary output buffer when a count value for an event exceeds a predetermined number;
flushing the cache memory;
incrementing count values for a second intermediate histogram of the second event type utilizing the cache memory;
outputting incrementing instructions with respect to the second event type to the temporary output buffer when a count value for an event exceeds a predetermined number; and
constructing a result histogram from the first intermediate histogram, the second intermediate histogram, and the output buffer.
